(19) United States
(12) Patent Application Publication
(10) Pub. No.: US 2024/0258535 A1
(43) Pub. Date: Aug. 1, 2024

(54) METHOD FOR SUPPLYING AN AIR BEARING OF A FLIGHT PROPULSION SYSTEM BY MEANS OF A FUEL CELL SYSTEM, AND FLIGHT PROPULSION SYSTEM

(71) Applicant: MTU Aero Engines AG, Muenchen (DE)

(72) Inventor: Barnaby LAW, Starnberg (DE)

(21) Appl. No.: 18/290,979

(22) PCT Filed: Aug. 2, 2022
(86) PCT No.: PCT/DE2022/100559

§ 371 Date: Jan. 22, 2024

(30) Foreign Application Priority Data
Aug. 6, 2021 (DE) 10 2021 120 471.2

(51) Int. Cl. H01M 8/04111; B64D 27/02; B64D 41/00; H01M 8/04089; H01M 8/04746

(52) U.S. Cl. CPC H01M 8/04111; B64D 27/02; H01M 8/04097; H01M 8/04776; B64D 2041/005; H01M 2250/20

(57) ABSTRACT

A supply device (10) and to a method (100) for supplying an air bearing (11) via a fuel cell system (12) having at least one anode (14) and at least one cathode (15) as well as a process gas device (17) for supplying the anode (14) and the cathode (15) with fuel and ambient air and for discharging spent process gases.

The invention relates to a method for supplying an air bearing by means of a fuel cell system having at least one anode and at least one cathode as well as a process gas device for supplying the anode and the cathode with fuel and ambient air and for discharging spent process gases.

### BACKGROUND

Air bearings use a thin film of pressurized gas to provide a low-friction, load-bearing interface between the surfaces. Because the two surfaces do not touch, traditional bearing-related problems such as friction, wear, particulates, and lubricant handling are avoided, providing distinct advantages in precision positioning, such as no backlash or stiction, and in high-speed applications. In particular, aerostatic air bearings need to be supplied with compressed air to create or maintain a pressure cushion during operation. Usually, a compressor is provided for supplying compressed air to the air bearing.

### SUMMARY OF THE INVENTION

Air bearings are preferably used in and for supporting high-speed machines, i.e., in particular in high speed ranges. Air bearings operate contact-free and thus nearly without abrasion. Therefore, air bearings have a very long life if properly designed and rated. However, continuously supplying the air bearing with a sufficient quantity of a compressed gas or gas mixture is crucial for trouble-free functioning of the air bearing.

In view of the above, it is an object of the present invention to provide an improved method for supplying an air bearing. Another object is to provide a supply device for an air bearing in connection with a fuel cell system. This is achieved in accordance with the invention by the teaching of the independent claims. Advantageous embodiments of the invention are the subject matter of the dependent claims.

The present invention provides in a first aspect a method for supplying an air bearing by means of a fuel cell system having at least one anode and at least one cathode as well as a process gas device for supplying the anode and the cathode with fuel and ambient air and for discharging spent process gases. A process gas is supplied from the process gas device of the fuel cell system to the air bearing as bearing gas.

In the context of the invention, an air bearing is a bearing in which two relatively moving companion bearing elements are separated by a gas mixture in the form of a bearing gas. An air bearing is, in particular, an aerodynamic bearing or an aerostatic bearing to which an, in particular compressed, gas mixture for creating and maintaining a gas cushion, gas gap, or gas film containing a gas mixture is supplied during operation. In particular, the air bearing may be designed as a nozzle-type air bearing, in which the pressurized gas mixture is passed through inlet nozzles into a bearing gap.

A fuel cell system includes, preferably a plurality of, fuel cells, which are arranged, for example, in the form of fuel cell stacks. Such a fuel cell arrangement, which accordingly includes at least one fuel cell, is referred to simply as “at least one fuel cell” in the context of the description of the invention. Accordingly, the plurality of fuel cells usually also includes a plurality of anodes, which are supplied with a fuel, such as, in particular, hydrogen, for generating electrical energy, and a plurality of cathodes, which are supplied with ambient air in order to feed the oxygen contained therein as an oxidizing agent to the fuel cell for generating electrical energy in cooperation with the anodes.

A process gas device is adapted for carrying process gas and supplies the fuel cell via the process gas with reactants required to generate electrical energy and discharges spent process gas from the fuel cell. For this purpose, the process gas device is adapted to supply fuel to the anode and to supply an oxidizing agent to the cathode, as well as to discharge or circulate in particular at least partially spent process gases. During operation of a fuel cell, a reducing agent, such as hydrogen, is supplied to the anode and an oxidizing agent, such as ambient air, is supplied to the cathode. At the anode, the hydrogen is catalytically oxidized, forming hydrogen ions and releasing electrons. These pass through the electrolyte, which is usually in the form of a membrane, into the cathode region, where they react with the oxygen supplied to the cathode and the electrons conveyed to the cathode via an external electric circuit, forming water. During oxidation of the ambient air in the fuel cell, further reaction gases may be formed, such as nitrogen, which are present in the, in particular spent, process gas in the process gas device and are discharged from the fuel cell. The process gas device thus forms an open gas circuit.

Using the proposed method, process gas is withdrawn from the process gas device of the fuel cell system and supplied to the air bearing as bearing gas. The process gas present in the fuel cell system is already in a compressed state, which reduces an additional compression effort to reach, for example, an operating gas pressure of the air bearing. This eliminates the need for a compressed air supply for air bearings, making it possible to reduce the complexity of supplying compressed air to the air bearing. In the method according to the invention, there is no need to provide a separate compressor to supply, for example, compressed ambient air to the air bearing.

In an embodiment of the method for supplying an air bearing, the bearing gas is additionally compressed prior to being supplied to the air bearing. The process gas present in the process gas device is at a certain system-related positive pressure. By additional compression, the bearing gas can be compressed to a predetermined pressure, in particular the operating pressure of the air bearing, and supplied to the air bearing to ensure reliable separation of the companion bearing elements of the air bearing.

In an embodiment of the method for supplying an air bearing, the bearing gas comes from an anode side of the fuel cell, in particular the anode outlet side, and is preferably withdrawn from an anode circulation loop. Fuel is supplied from a fuel reservoir to the fuel cell at the anode side via the process gas device, and the fuel is substantially consumed in the fuel cell. The spent process gas is discharged from the fuel cell, and fuel that is not completely consumed may be returned to the anode of the fuel cell via the process gas by means of an anode circulation loop or, in particular, may be released into the environment. Advantageously, process gas which has already passed at least once through the fuel cell, i.e., spent process gas, is supplied to the air bearing as bearing gas. By reusing the process gas or its pressure energy, it is possible to increase the efficiency of the fuel cell system.

In an embodiment, the air bearing is supplied with process gas from the fuel reservoir as bearing gas. For example, hydrogen may be withdrawn as a fuel directly from the fuel reservoir or from the process gas device and supplied to the air bearing prior to being supplied to the fuel cell. In this case, the process gas is preferably pre-compressed, or the bearing gas may be additionally compressed prior to being supplied to the air bearing. Supply of bearing gas from the fuel reservoir can be accomplished regardless of whether the fuel cell system is in operation or idle. In this way, supply to the air bearing is ensured at all times, regardless of the operating state of the fuel cell system or fuel cell.

In an embodiment of the method for supplying an air bearing, the bearing gas contains nitrogen or dinitrogen (N₂). In an embodiment of the method, nitrogen formed in the fuel cell can be supplied via the process gas to the anode at the anode side of the fuel cell. During operation of the fuel cell, nitrogen may accumulate in the process gas device, in particular when recirculating spent process gas, the accumulated nitrogen being at least sporadically discharged. By using the nitrogen-containing process gas to be discharged for supplying the air bearing, it is possible to increase the overall efficiency of the method. Supplying nitrogen as an inert gas to the air bearing may prevent a degradation process within the air bearing because moisture and other residual gases are displaced when using an inert gas.

In an embodiment of the method for supplying an air bearing, the bearing gas comes from a cathode side of the fuel cell. At the cathode side of the fuel cell, ambient air from the environment is supplied via the process gas device and reacts in the fuel cell. The spent ambient air is removed from the fuel cell via the process gas by means of the process gas device and can be released into the environment. Supplying process gas to the air bearing from the cathode side has the advantage that the process gas from the environment is available in unlimited quantities and is already compressed when provided in the process gas device.

In order to achieve the objects, a second aspect provides a supply device for an air bearing in connection with a fuel cell system. The fuel cell system has at least one anode and at least one cathode as well as a process gas device for supplying the anode and the cathode with fuel and ambient air and for discharging spent process gases. The supply device has at least one supply line from the process gas device to the air bearing, via which a process gas can be supplied from the process gas device of the fuel cell system to the air bearing as bearing gas.

The at least one fuel cell of such a fuel cell system has already been described above in connection with the method for supplying an air bearing by means of a fuel cell system. The features and properties mentioned there are also applicable to the process gas device and the at least one fuel cell. Such a process gas device may include, for example, a fuel supply by means of which a fuel, preferably in the form of hydrogen, is supplied to the anode. Furthermore, the process gas device preferably includes an air supply by means of which an oxidizing agent is supplied to the cathode via the ambient air, so that the hydrogen can react with the atmospheric oxygen in the fuel cell, forming, for example, gaseous reaction products and water. The water can be discharged into the environment; remaining hydrogen as well as the gaseous reaction products or the residual gas can be released directly into the environment via the process gas device.

The process gas device includes a conduit system which connects a fuel reservoir and the environment to the fuel cell, in particular its anode(s) and cathode(s), for gas exchange in at least one open gas circuit. Preferably, the process gas device has at least one valve, a distributor, or a compressor for conveyance of the process gases.

The reaction taking place in the fuel cell system between the fuel and the ambient air produces, for example, spent process gases which can be used for supplying the air bearing. For example, if hydrogen is used as a fuel, the reaction occurring in the fuel cell produces energy, water, and residual gas. While the water can be discharged into the environment surrounding the fuel cell, the residual gas in the process gas device can be supplied via the supply line to the air bearing to build up and maintain an operating pressure of the air bearing, to ensure functioning of the air bearing, and to prevent damage to the air bearing as a result of a pressure drop.

Using the proposed supply device, process gas can be provided to the air bearing as bearing gas by means of the fuel cell system. The bearing gas can be used to build up and/or reduce an operating pressure, for example when energizing and/or de-energizing an aerodynamic air bearing, in order to prevent damage to the bearing outside of the functional operating range that provides the aerodynamic bearing pressure. This makes it possible to counteract damage, particularly during restart, and an associated reduction in the service life of the aerodynamic air bearing.

Arranging the air bearing and fuel cell system in relative spatial proximity to each other, in particular directly adjacent to each other, allows rapid supply of compressed bearing gas in order to reduce losses, in particular a pressure loss, over the supply line. If the fuel cell system is used, for example, to provide energy for a motor or drive supported by the air bearing, a spatial association of the air bearing with the fuel cell system via a short transport path can be advantageous for the air bearing operation.

In an embodiment of the supply device, the supply line has a compression device. The compression device may, for example, be in the form of a piston compressor or a screw compressor. The process gas is, in particular additionally, compressed by the compression device prior to being supplied to the air bearing. In particular, the bearing gas for the air bearing is compressed to a pressure above atmospheric of at least 3 to 6 bar, the pressure above atmospheric preferably corresponding to the operating pressure of the air bearing. For vehicle applications, a compression to a pressure of, in particular, 4 to 8 times the atmospheric pressure may be provided.

For aircraft applications, increased compression power is required to compress ambient air to the predetermined operating pressure of the air bearing, especially during flight. Since, according to the proposed supply device and supply method, the bearing gas comes from the process gas device and, thus, the process gas is already in a compressed state, an absolute or additional effort for compression is reduced as compared to, for example, an approach where ambient air is compressed by a compressor.

In an embodiment of the supply device, the supply line connects the anode side of the fuel cell, in particular the anode outlet side, to the air bearing. The anode side of the fuel cell includes, in particular, an anode circulation loop, as already explained with regard to the method. Process gas consumed in the fuel cell, in particular in the form of nitrogen, is supplied to the anode via the anode side of the fuel cell. By arranging the supply line in this way on the anode side of the fuel cell, a composition of the process gas that is supplied to the air bearing can at least partially be controlled and/or monitored.

In in embodiment of the supply device, the air bearing is configured for supporting a rotating device, in particular a rotating machine. A rotating device preferably has at least one element rotating about an axis, in particular its own axis, or the device is supported such that it is rotatable as a whole relative to the air bearing.

In an embodiment of the supply device, the air bearing is configured for supporting a turbocompressor or an, in particular high-speed, centrifugal compressor. Using the inventive device, such an air bearing can be at least additionally supplied with bearing gas in order to ensure, or at least assist in, an even supply of bearing gas to the air bearing and, thus, contact-free support under high loads.

In an embodiment of the supply device, the air bearing is designed as a linear or flat air bearing which allows the companion bearing elements to move linearly relative to each other. For example, air bearings of linear drives, such as those used, for example, for measurement applications or production technologies, may have a supply device according to the invention or be operated with, or at least assisted by, a method according to the invention. In addition, it is also possible to envisage an at least assistive application in the field of transport systems, in particular air cushion transport systems, or medical technology.

In in embodiment of the supply device, the air bearing is associated with a motor, in particular an electric motor. The electric motor may at least partially be supplied and/or operated with the energy generated in the fuel cell system. The electric motor preferably has a rotor and a stator. Both the rotor and the stator may be supported by the air bearing. Advantageously, the fuel cell system is disposed in spatial proximity to the air bearing and in particular in spatial proximity to an engine or drive that is operated with the energy generated in the fuel cell system in order to keep line-related losses low and to be able to use the bearing gas close to the source.

In an embodiment, the motor may be designed as a ring motor or torque motor with a hollow shaft. A ring motor preferably includes a rotor of a substantially hollow-shaft-type design and/or a stator of a substantially hollow-shaft-type design. The ring motor may be designed as an external-rotor motor, where the stator is located inside and the rotor is located outside, or as an internal-rotor motor, where the rotor is located inside and the stator is located outside. In torque motors, external rotor motors are more common because they provide greater torque for the same size because of the relationships described below. The bearing action between the rotor and stator can be ensured by an air bearing using the supply device according to the invention. External support of a torque motor by means of an air bearing can be enabled or at least assisted by the inventive supply device.

In principle, a supply device according to the invention or a method according to the invention can also be used to, in particular at least partially, assist an existing compressed gas supply system for an air bearing.

Another aspect of the invention relates to a flight propulsion system including a fuel cell system and a supply device, the flight propulsion system having at least one air bearing that can be supplied with a bearing gas by means of the supply device. The air bearing may be configured to support at least one drive rotor and support the at least one drive rotor.

A further aspect of the invention relates to a use of the supply device according to one or more embodiments of the preceding description for carrying out one or more embodiments of the also previously described method for supplying an air bearing.

### BRIEF DESCRIPTION OF THE DRAWINGS

Further features, advantages, and possible applications of invention will be apparent from the following description taken in conjunction with the figures, in which:

FIG. 1 is a schematic view of an exemplary inventive supply device for an air bearing in connection with a fuel cell system; and

FIG. 2 is a schematic flow chart of the method according to the invention.

### DETAILED DESCRIPTION

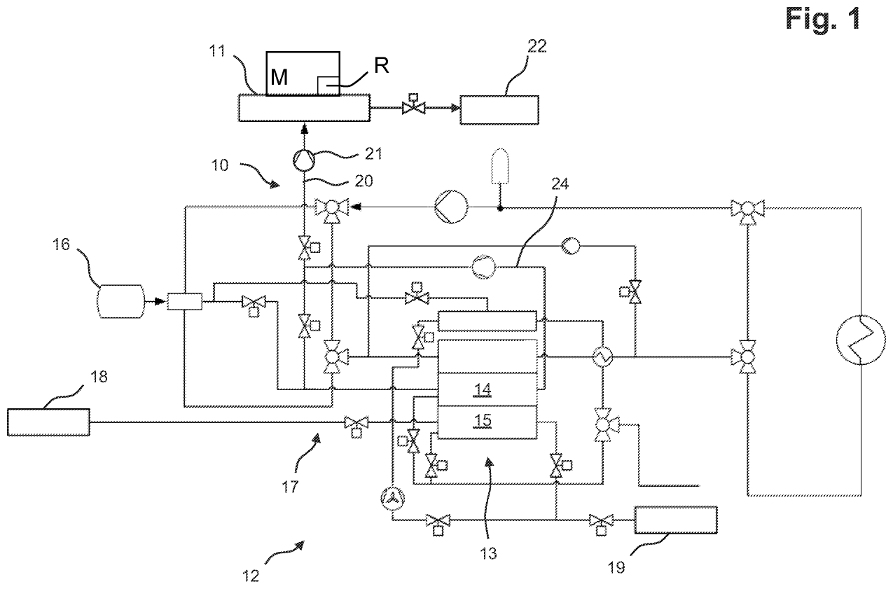

FIG. 1 shows in schematic form an exemplary supply device 10 for an air bearing 11 according to the invention in connection with a fuel cell system 12. Fuel cell system 12 includes a fuel cell 13 having an anode 14 and a cathode 15. Anode 14 is supplied with fuel, in the exemplary embodiment with hydrogen, from a fuel reservoir 16 via a process gas device 17. Cathode 15 is supplied via process gas device 17 with ambient air taken from environment 18. The ambient air or the atmospheric oxygen contained therein serves as an oxidizing agent for generating electrical energy via fuel cell 13.

In fuel cell 13, hydrogen can react with the atmospheric oxygen, producing energy, water, and residual gas. The water can simply be discharged into the environment. Fuel that that is not completely consumed can be released directly into environment 19 or returned to anode 14 via an anode circulation loop 24 of process gas device 17.

In the exemplary embodiment shown in FIG. 1, a supply line 20 connects the anode side of process gas device 17 and its anode circulation loop 24 to air bearing 11. Process gas from process gas device 17 can be supplied via supply line 20 to air bearing 11 as bearing gas. Particularly advantageously, air bearing 11 is supplied with spent process gas from the anode side of process gas device 17 or fuel cell 13, the spent process gas having passed through fuel cell 13 at least once.

Supply line 20 has a compression device 21 by means of which the process gas can be at least additionally compressed in order to compress the bearing gas to an operating pressure of air bearing 11. Bearing gas can be released from air bearing 11 into environment 22.

Preferably, air bearing 11 is designed as a rotary air bearing and is adapted to support a motor (shown solely schematically as M with a rotor R in FIG. 1), in particular an electric motor, or a drive. This motor or drive is preferably supplied with energy that is generated during operation of fuel cell system 12.

In an embodiment not shown, supply line 20 may also connect a cathode-side part of process gas device 17 or the fuel reservoir 16 to air bearing 11. When air bearing 11 is supplied from the fuel reservoir 16, bearing gas can be supplied independently of the operation of fuel cell 13 or fuel cell system 12.

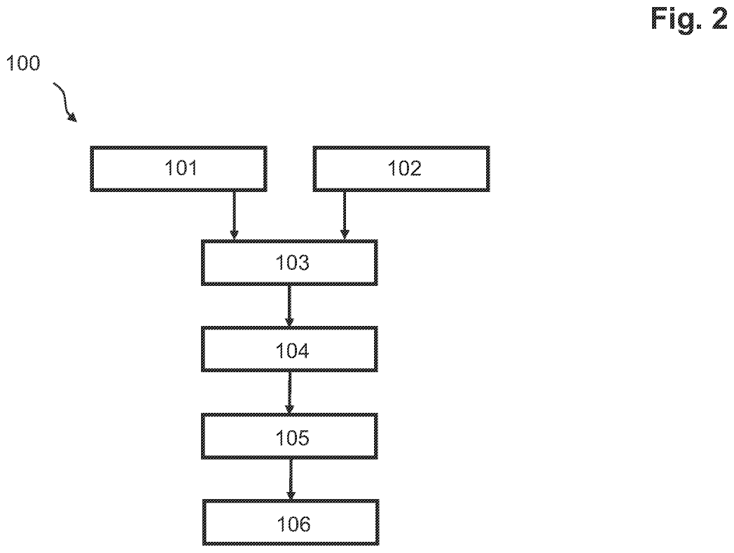

FIG. 2 shows a schematic flow chart of the inventive method 100 for supplying an air bearing 11 by means of a fuel cell system 12 having at least one anode 14 and at least one cathode 15 as well as a process gas device 17 for supplying the anode 14 and cathode 15 with fuel and ambient air and for discharging spent process gases.

In the exemplary method, fuel, for example hydrogen, is supplied to anode 14 via the process gas device 17 in a step 101. In a step 102, ambient air is supplied to cathode 15 via process gas device 17. Steps 101 and 102 can be carried out substantially simultaneously. In a step 103, the hydrogen reacts with the atmospheric oxygen of the ambient air in fuel cell 13, producing energy, water, and spent process gas. In a step 104, the spent process gas is returned to anode 14 or the anode inlet side from the anode outlet side via an anode circulation loop 24 of process gas device 17. In a step 105, spent process gas of process gas device 17 is supplied to air bearing 11 as bearing gas via a supply line 20. In a step 106, the spent process gas is compressed to a predetermined operating pressure of air bearing 11 prior to being supplied to air bearing 11.

In particular, the supply device 10 shown schematically in FIG. 1 is suitable for carrying out the method 100 described in FIG. 2.

### LIST OF REFERENCE NUMERALS

10 supply device
11 air bearing
12 fuel cell system
13 fuel cell
14 anode
15 cathode
16 fuel reservoir
17 process gas device
18 environment
19 environment
20 supply line
21 compressor
22 environment
24 anode circulation loop

What is claimed is:

1-13. (canceled)

14. A method for supplying an air bearing of a flight propulsion system via a fuel cell system having at least one anode and at least one cathode as well as a process gas supply for supplying the anode and cathode with fuel and ambient air and for discharging spent process gases, the method comprising:
supplying the process gas from the process gas supply of the fuel cell system to the air bearing as bearing gas.

15. The method as recited in claim 14 further comprising additionally compressing the bearing gas prior to being supplied to the air bearing.

16. The method as recited in claim 14 wherein the bearing gas comes from an anode side of the fuel cell.

17. The method as recited in claim 16 wherein the bearing gas is withdrawn from an anode circulation loop.

18. The method as recited in claim 14 wherein the bearing gas contains nitrogen dioxide.

19. The method as recited in claim 14 wherein the bearing gas comes from a cathode side of the fuel cell.

20. The method as recited in claim 14 wherein the air bearing is supplied with further process gas from a fuel reservoir as the bearing gas.

21. A flight propulsion system comprising:
a fuel cell system having at least one anode and at least one cathode as well as a process gas supply for supplying the anode and the cathode with fuel and ambient air and for discharging spent process gases, and further including an air bearing supply for an air bearing, the air bearing supply being connected to the fuel cell system; and
at least one supply line from the process gas supply to the air bearing, a process gas suppliable via the at least one supply line from the process gas supply of the fuel cell system to the air bearing as bearing gas.

22. The flight propulsion system as recited in claim 21 wherein the supply line has a compressor.

23. The flight propulsion system as recited in claim 21 wherein the supply line connects an anode side of the fuel cell to the air bearing.

24. The flight propulsion system as recited in claim 21 wherein the air bearing is configured for supporting a rotating device.

25. The flight propulsion system as recited in claim 21 wherein the air bearing is designed as a linear air bearing.

26. The flight propulsion system as recited in claim 21 wherein the air bearing is associated with a motor.

27. The flight propulsion system as recited in claim 26 wherein, in particular an electric motor.

28. The flight propulsion system as recited in claim 26 wherein the air bearing is configured to support a drive rotor.
